(19) United States
(12) Patent Application Publication
(10) Pub. No.: US 2012/0105825 A1
(43) Pub. Date: May 3, 2012

(54) MEASURING DEVICE FOR NONCONTACT MEASUREMENT OF DISTANCES TO A TARGET OBJECT

(75) Inventors: Torsten Gogolla, Schaan (LI); Stefan Tiefenthaler, Meiningen (AT); Herwig Habenbacher, Feldkirch-Tosters (AT); Christoph Würsch, Werdenberg (CH); Peer Schmidt, Lindau (DE); Jean-Phillippe Doyen, Walenstadt (CH)

(73) Assignee: Hilti Aktiengesellschaft, Schaan (LI)

(21) Appl. No.: 13/283,788

(22) Filed: Oct. 28, 2011

(30) Foreign Application Priority Data
Oct. 29, 2010 (DE) DE102010043 136.2

(51) Int. Cl. G01C 3/04

(52) U.S. Cl. 356/8

(57) ABSTRACT

A measuring device, having: a housing; a distance measuring unit situated in the housing uses an optical measuring beam, with the aid of which the distance between a reference point and at least one measuring point on a target object is measurable without contact; a photoelectric image acquisition unit situated in the housing having a viewfinder and camera lens situated in the housing as well as an image path connecting them for detecting target points of the target object, an image processing unit and a control and computation unit with the aid of which the image of the image processing unit is displayable. The image processing unit defines target points pixels in exactly one single photoelectric image, the control and computation unit allocating the distance of the reference point to the measuring point to at least one of the pixels, the allocation available for further processing.

This claims the benefit of German Patent Application DE 10 2010 043136.2, filed Oct. 29, 2010 and hereby incorporated by reference herein.

The present invention relates to a measuring device, in particular in the form of a handheld device, for a noncontact measurement of a distance to a target object. The present invention also relates to a method for noncontact measurement of distances on a target object.

### BACKGROUND

A measuring device may be used as a handheld distance meter using a suitably designed laser measuring unit, for example.

A noncontact measurement of a distance to a target object is usually made with the aid of an optical measuring beam, for example, a laser beam. Regardless of the measuring beam used, fundamentally different methods are known for distance measuring; for example, a distance to a target object may be determined in a noncontact method with the aid of a travel time measurement, a phase measurement or laser triangulation. For implementing these or similar methods, a housing of the measuring device provides a distance measuring unit, which utilizes an optical measuring beam situated in the housing, with the aid of which the distance to the target object is measurable without contact. An exemplary distance measuring unit which is advantageously designed for noncontact distance measuring via a travel time measurement is described in DE 101 12 833 C1, for example. It has a beam emitting unit in the form of a laser unit. In addition, an optical unit having optical elements for beam guidance is provided. The optical elements include at least one transmission and reception optical unit. A transmission optical unit is situated in an optical transmission path having an optical axis for emitting a measuring beam to the target object. A receiving optical unit is situated in an optical reception path having an optical axis for receiving the measuring beam reflected or backscattered by the target object.

Distance is understood within the scope of this patent application to refer to a distance measured to the measuring point on the target object. In particular distance is understood to be a distance being essentially between the measuring device and the target object, concretely between a reference point on the measuring device and the measuring point on the target object, so a distance is oriented essentially transversely (usually at a right angle) to a lateral surface of the target object. Inasmuch as the term distance is used more generally, it thus includes distances to the target object. If the term distance is used specifically, this refers in particular to a distance between target points present on the target object, i.e., in particular distances on or essentially aligned to a lateral surface of the target object. In the present case, distance refers specifically to a distance in the lateral surface or in a lateral plane of the target object or allocated to the target object. A distance is thus measurable specifically on the target object itself in particular.

The distances in the present specific case are distances which are not accessible to direct measurement by a distance meter of the aforementioned type, in contrast with the aforementioned distances. For example, this relates initially to lengths but also to surface contents, which may be related thereto and are to be found on a building façade or the like, for example. These lengths are not measurable via a conventional distance measurement of the type described above. A simple effective measurement of lateral distances in surfaces or planes on a target object, preferably as accurate as possible, would be desirable in practice.

Essentially known methods of photogrametry, for example, are usually limited to a mere visual so-called 3D modeling of camera shots without being associated with any dimensions of lateral distances on the target object or in the surface or in the plane of the target object. For example, WO 00/25089 describes a device for three-dimensional representation of an object in which a distance measuring unit records distances of a number of points of an object within a target region. There is a link to a two-dimensional image of the target object only to generate a three-dimensional representation of the object therefrom without providing any quantitative information about distances in the plane of the target object or on the target object.

EP 2 026 077 A1 describes a system for noncontact recording of three-dimensional coordinates which is relatively complex, as are other systems of this type. An image coordinate system, which refers to the recorded three-dimensional image, succeeds in being transformed into the object coordinate system within which the object is to be measured. On the one hand, however, two or more cameras recording the target object from different positions at the same time are necessary. On the other hand, marks in the object coordinate system on which the aforementioned transformation is based are required.

### SUMMARY OF THE INVENTION

Such systems may be too complex for applications at construction sites or in construction and renovation jobs and are susceptible to problems and are thus ultimately not manageable. In particular providing marks in an object coordinate system should be avoided if at all possible because this is obviously impossible or very difficult in the case of target objects at a great distance or target objects that are simply inaccessible. In particular, placing marks on the target object entails the risk of accidents, which should ultimately be avoided.

Instead, it is desirable to simplify the measurement of lateral distances on a target object—if necessary, also the measurement of distances to the target object—and to make it more reliable and more efficient. It has also been found that an accuracy in the percentage range in the profile of requirements usually encountered at construction sites or the like is sufficient to be able to meet requirements for initial user needs. Comparatively simple profiles of requirements exist, for example, when determining surfaces on the target object—in particular lateral surfaces and lateral distances on the target object characterizing these surfaces.

A measuring device mentioned in the introduction and having a housing as well as a distance measuring unit situated in the housing and utilizing an optical measuring beam and having a photoelectric image acquisition unit situated in the housing offers an approach for doing so. However, this approach may be made simpler than is described in EP 2 023 077 A1, for example. It is fundamentally known that a distance measuring unit for distance measuring and a photoelectronic image acquisition unit may be combined in one housing—like a measuring device of the type defined in the introduction.

A measuring device of the type defined in the introduction is known from WO 2008/155657 or JP 08021878, for example. A distance measuring unit and a photoelectric image acquisition unit are implemented in such measuring devices, but they are situated in a housing where they are uncoupled, one image of a measuring point on the target object being superimposed on a photoelectric image merely through the use of software. For example, JP 08021878 describes how the position of a scanned measuring point of the distance measuring unit detected with the aid of the photodiode array is superimposed on the photoelectric image of the target object within the context of the software application and only then is the image displayed on a display screen. Similarly in WO 2008/155657 the display of the distance meter and the photoelectric image of a camera are superimposed. Such software-based approaches have proven to be inadequate in compact measuring devices, in particular those which are handheld.

Accordingly, approaches such as that described in EP 1 407 227 B1 merely visualize a measuring point on the target object via the photoelectric image acquisition unit—in other words, a photoelectric image acquisition unit in these systems acts like a telescopic sight to make the measuring point of a distance measuring unit on the target object visible for the eye of the user. It is thus impossible to measure lateral distances on the target object, in particular on surfaces or on lateral surfaces of the target object.

DE 100 55 510 B4 by the present applicant discloses a measuring device of the type defined in the introduction in which a distance measuring unit and also a photoelectric image acquisition unit are provided in a housing. A control and computation unit calculates a virtual measuring spot and displays it graphically on the display screen, so that a parallax error for a distance measurement is correctable. Such a measuring device also measures only distances between the measuring device and the target object without lateral distances on the target object itself being determinable.

It is an object of the present invention to provide a measuring device and a method of the type defined in the introduction with the aid of which distances to a target object are determinable in a comparatively efficient manner which is simple in particular. Lateral distances on a surface of the target object such as, for example, lateral distances on a plane of the target object are to be determinable in particular. It should be possible in particular to indicate the lateral distances on the target object at least approximately. In particular the base should be created for enabling a documentation and attribution of measured distances, i.e., in particular lateral distances on the target object, in a manner that is easily visualized with an easily handled measuring device, in particular in the form of a handheld device. In particular it should additionally be possible to indicate distances between the measuring device and the target object.

The present invention is based on the consideration that a control and computation unit, having a memory and taking into account the available computation and storage capacities, may also be configured for handheld measuring devices in such a way that it is possible to provide at least approximate information about lateral distances on the target object by using the results of a distance measuring unit and a photoelectric image acquisition unit. The present invention is also based on the consideration that a simplification of a processing operation in the control and computation unit according to the proposed concept is advantageous. For this purpose, the present invention initially provides an image processing unit which is designed to define at least a number of the target points on the target object as a number of corresponding pixels in at least one photoelectric image. The number of points in the present case is understood to be an integer of one, two, three, four, etc., or more points. The measuring point may but need not necessarily be part of the image. A measuring point is advantageously part of the image. In particular a measuring point may be one of the target points. This is not normally the case but it may prove to be advantageous. In other words, the concept of the present invention is based on the analysis of initially exactly one photoelectric image and the single measuring point recorded with the photoelectric image. In particular the concept of the present invention may already be implemented advantageously on the basis of a single photoelectric image obtained with a single [photographic] shot. In particular it is sufficient for implementing the concept that the photoelectric image acquisition unit has a single search lens and camera lens. However, the present invention is not limited thereto. Likewise there is a significant advantage of the concept in its comparatively simple implementability.

The present invention has recognized that the distance measuring device supplies a distance between a reference point and the measuring point on a target object simultaneously or in real time to the recording of the photoelectric image. Accordingly, the present invention additionally provides that the control and computation unit is designed to assign the pixel, which is defined and corresponds to a target point, to the distance of the reference point to the measuring point. An allocation formed in this way between the distance supplied by the distance measuring unit and the measuring point on the one hand and a pixel defined in the image of the photoelectric image acquisition unit on the other hand has proven to be a sufficient basis for approximately determining lateral distances on the target object in particular.

Such an allocation may be implemented in a fundamentally different manner within the scope of the concept of the present invention, for example, by a suitable reference to a corresponding value for the distance and the pixel. The values may be compiled in lists or fields or other allocations which are used for assigning value. Within the scope of a refinement, the allocation may be available as a separate numerical field or a numerical field formed by mutual reference, for example. The definition of a pixel may preferably be available as pixel coordinates and the distance may be available as a distance measure. The allocation as a triple number advantageously in particular includes the pixel coordinate difference of two pixels and the distance of the reference point to the measuring point as a distance measure. The control and computation unit may advantageously be designed with a memory, the allocation of the distance and the at least one pixel being stored as an allocation in the memory.

Within the scope of a particularly advantageous refinement of the present invention, it is provided that exactly one single photoelectric image results from a single recording of the target object. In particular it is provided for this purpose that precisely one measuring point is allocated to the photoelectric image. The measuring point is advantageously allocated to one of the number of pixels in the single photoelectric image but not to one of those pixels allocated to one target point. Such a recording of a photoelectric image with a measuring point and an additional distance measurement to the measuring point may be accomplished using a single viewfinder lens and camera lens, which greatly simplifies the design of the measuring device.

Additional advantageous refinements of the present invention are characterized in the subclaims and specify the details of advantageous possibilities of implementing the concept explained above within the scope of the object of the present invention and also with regard to additional advantages.

Within the scope of one advantageous refinement, the allocation as a triple number, for example—including the definition of a pixel as a pixel coordinate and a distance as a distance measure—may be made available. The triple number is advantageously suitable for further processing by the control and computation unit. The control and computation unit may therefore have a distance module, for example, in a particularly preferred manner.

The distance module is advantageously designed to define a distance between a first pixel and a second pixel as a pixel distance and to allocate a distance measure to the pixel distance corresponding to the distance of the target points on the target object corresponding to the pixels. This may be implemented, for example, within the scope of a suitably programmed software module for image processing. Within the scope of a particularly preferred refinement, it is provided that the distance module has an input for a reference measure and is designed to determine an image scale as an image conversion factor at least approximately from the reference measure and a distance measure to the measuring point. The image conversion factor is used in a particularly preferred manner to allocate a distance measure to the aforementioned pixel distance. This approach makes it possible to also detect lateral distances on the target object using a distance measure even with the computation power available in a handheld device. Within the scope of a particularly efficiently devised refinement of the present invention it has proven advantageous that a first reference measure is formed as a focal length of the viewfinder and/or camera lens. The focal length of the viewfinder and/or camera lens is advantageously used to this extent to be able to allocate a distance measure to the pixel distance. A second reference measure is advantageously formed as a pixel variable. The pixel variable may be different in different pixel coordinate directions of the image. The pixel variable may advantageously be approximated isotropically. An image scale is preferably determined in particular as the ratio of a focal length and a distance multiplied by a pixel variable. As recognized in the refinement, the use of the first and second reference measures in particular results in a preferred determination of the image scale which is also performable with comparatively little computation power and also leads to results that are approximately very usable in any case. It is possible in this way in particular to identify a measuring point of the distance measuring unit unambiguously in the photoelectric image of the target object, following the concept of the present invention, practically together with a distance measurement and recording of a photoelectric image, and to specify lateral distances on the target object with reference to a reference measure.

The exactly one single photoelectric image preferably results from a single recording of the target object, and precisely one measuring point is allocated to the photoelectric image. In particular it is provided that the number of target points is defined essentially in a plane in which the measuring point is also located, for the target points in exactly one single photoelectric image. The plane, which is also referred to as a reference plane, may advantageously be defined by the measuring point and a normal vector which is advantageously given approximately by the direction of view of the camera. This further definition of the reference plane is based in particular on the advantageous assumption that a user triggers a measurement essentially from a direction perpendicular to a plane of the target object which is to be measured. In particular, the concept of the refinement may be applied with justifiable precision to distances to be measured in a reference plane, forming approximately an angle of 90°±25° to a direction of view of the camera. In other cases, in particular in cases in which the measuring point lies in a plane having distances forming an acute angle to the direction of view, it has proven advantageous to transform the target points defining the distances to be measured into a reference plane which fulfills the above advantageous prerequisites and to do so through suitable image processing algorithms, if necessary using additional sensor data and user interactions. This may be done, for example, by rotation of the plane about the measuring point. A measuring point should be located as close as possible to the lateral distance to be measured. In general, a reference plane may be defined on the target object at least through the measuring point on the target object and its distance—in particular also the direction of the distance—to the reference point in the measuring device—supported if necessary by processing of the photoelectric image in an image processing unit and/or by a user interaction. A position of a number of target points may be defined in the reference plane—merely approximately if necessary. In particular it has proven sufficient in general if the number of distance points is located only near the reference plane, within the scope of an acceptable deviation, which is small in relation to the distance. This includes, for example, the frequently encountered situation in which the measuring point is placed on a mostly essentially planar surface of the target object such as a building façade or the like, while the target points defining the lateral distances to be measured are themselves in front of or behind the aforementioned planar surface. This is often the case in the aforementioned situation for balconies, window ledges, door recesses and the like in the building façade, for example. This refinement which includes approximations is advantageous for most applications in which planar surfaces are to be measured, for example, walls or the like. A comparatively accurate determination of lateral distances in such a plane is advantageously achieved when this plane is oriented as a reference plane practically at a right angle to the direction of view of the photoelectric image acquisition unit (normal direction) and when the measuring point is in this plane. In particular such planes are referred to here as the reference plane and their normals are referred to as the reference normals. Within the scope of another advantageous refinement of the present invention it is provided that the control and computation unit has a joining module which is designed to process a number of individual photoelectric images, each resulting from a single recording of the target object, each with exactly one allocated measuring point together, in particular to process them in combination, in particular combining them to form a panoramic image. Multiple photoelectric images may advantageously result from multiple recordings of the target object. In this regard, it is provided in particular that exactly one measuring point is allocated to each photoelectric image, namely as one of the number of pixels in the corresponding photoelectric image. In particular a lateral distance between a first pixel in a first image and a second pixel in a second image may be defined as the pixel distance, and a distance measure of the target points may be allocated to the pixel distance. The image processing may advantageously be designed to form relationships between the first image and the second image in such a way that a pixel distance may be specified and a distance measure of the target points is to be allocated to the pixel distance—if necessary with a different image scale in the first and second images.

Within the context of an additional advantageous refinement of the present invention it is provided that exactly one photoelectric image results from multiple individual recordings of the target object and is compiled as a panoramic image from multiple individual recordings of the target object. Exactly one measuring point of the distance measurement is allocated to each individual recording of the target object. Thus multiple measuring points corresponding to the individual images are allocated to the single compiled photoelectric image, namely as one of the number of pixels in the single composite photoelectric image. The joining module may advantageously be designed to allocate a number of measuring points formed from the allocated measuring points, in particular a number of averaged measuring points to a single measuring point, if necessary.

The distance module may be refined in a particularly advantageous manner to define a number of distance measures between a number of target points in a surface of the exactly one single photoelectric image. In this way, a number of lengths in a lateral surface of the target object may be determined advantageously. For example, these may be secured in noticeable positions of the image. A definition of the positions may take place automatically, either entirely or partially, for example, based on contrast or with the aid of some other image processing filter function of an image processing unit and/or control and computation unit using optical analysis. A definition may also be provided by user interaction, again either partially or entirely, in particular in the form of a user interaction via an input device or the electronic display unit. The electronic display unit may be implemented, for example, as a touchscreen system having a suitable functionality, for example, a snap function (allocation of an approximate touch position to a noteworthy image position in the vicinity).

In concrete terms, a façade of a building may be completely surveyed in this manner. Based on that it has also proven advantageous to define a surface measure of a polyhedron formed within a number of target points in a surface of the exactly one single photoelectric image. A user may utilize such an at least approximately determined surface measure in an appropriate manner to be able to estimate, for example, the construction material for a surface to be processed.

In particular the concept of the present invention in a refinement is suitable for refining an electronic display unit to visualize the documentation and attribution of measured distances on a lateral surface or area of the target object satisfactorily for a user. For example, the electronic display unit may be designed to display at least one distance measure and/or surface measure between at least one first pixel and one second pixel in the image.

This or another may be in particular a display without a defined distance from the measuring point of the distance measuring unit. It has been found that a user does not need the distance to the measuring point in each case but instead is interested more in lateral distances on a lateral surface of the target object. Likewise in one advantageous refinement, an electronic display unit may be configured in the housing, to display a distance to the measuring point as an alternative or in addition to the distance measure.

The distance measuring unit advantageously has: a beam unit in particular a laser unit and optics having optical elements, including at least transmission and reception optics, an optical transmission path having an optical axis for emitting the measuring beam to the target object and an optical receiving path having an optical axis for receiving the measuring beam reflected by the measuring point.

The transmission path is advantageously guided biaxially to the reception path via a separate output element of the transmission optics, in particular an output lens. Alternatively, the transmission path may also be guided coaxially to the reception path via a shared output element of the transmission and reception optics, in particular via a collimator lens.

The distance measuring unit which utilizes the optical measuring beam with the aid of which the distance to the target object is measurable without contact may advantageously be implemented in a so-called biaxial variant or advantageously in a so-called coaxial variant. The aforementioned naming refers to the relative configuration of the transmission path and the reception path to one another. In the biaxial variant it is advantageously provided that the transmission path is guided biaxially to the reception path via a separate output element of the transmission optics. The output element of the transmission optics may advantageously be an output lens or the like.

The distance measuring unit and the photoelectric image acquisition unit may advantageously be implemented constructively in the measuring device, but different variants are possible as needed. Essentially a transmission path, a reception path and an image path of the distance measuring unit and the photoelectric image acquisition unit may be implemented separately (also referred to as biaxially) or at any rate may be partially combined (also known as coaxial). For a complete coaxial configuration of the paths, a shared output element of the image path and of the transmission and/or reception paths may be provided in particular.

It has been found that within the context of one refinement, the control and computation unit may be expanded to correct for optical distortions in the photoelectric image acquisition unit. The control and computation unit and/or the image processing unit advantageously has/have a transformation module which is designed to make available to the distance module a correction measure for a perspective distortion of a polyhedron in particular, which is formed by a number of target points. With the transformation module, target points may be transformed into the reference plane in addition or alternatively, if necessary, using additional sensor data of an inclination sensor, a yaw rate sensor or the like, for example, or using a user interaction. In particular this relates to corrections of perspective distortions with respect to a vanishing point. A correction module for correction of image distortions caused by elements of the image acquisition unit is also advantageously provided, so that even temperature-dependent effects are correctable based on a model or using tabular values.

The measuring device is suitable in a particularly advantageous manner for selecting distinctive target points such as, for example, edge end points, biaxial intersection points or triaxial intersection points or the like as the number of pixels. In other words, pixels may be predefined with the aid of the measuring device in an advantageous manner, in such a way that distinctive target points on the target object are definable as pixels in the photoelectric image.

This may be accomplished, for example, through a choice by the user, for example, via a control panel. This may also be done automatically, for example, with the aid of the image processing unit, e.g., based on contrast analyses, Hough transformation or similar image filters. The measuring device is preferably expandable with a coupling module which allows coupling of additional applications such as flat memory, a GPS system or other available distance information carriers in a suitable manner. This is suitable in a particularly advantageous manner to compensate for the distance measures which may be defined by the distance module with other distance information. The coupling module is advantageously designed to allocate a distance of the distance module to a distance of a distance information carrier. This may be utilized advantageously, for example, to define plans, locations or orientations of the target object or measuring device with respect to specifications and to identify with them. This may be utilized in an advantageous manner for BIM (Building Information Modeling) applications.

### BRIEF DESCRIPTION OF THE DRAWINGS

Exemplary embodiments of the present invention will now be described below with reference to the drawings, which are not necessarily scale drawings of the exemplary embodiments but instead the drawings are shown schematically and/or in a slightly distorted form for the purpose of illustration. With regard to additions to the teachings which are directly recognizable from the drawings, reference is made to the related art. To be taken into account here is the fact that a variety of modifications and changes with respect to the form and the detail of a specific embodiment may be made without deviating from the general idea of the present invention. The features of the present invention disclosed in the drawings and in the claims may be essential to the refinement of the present invention either individually or in any combination. Furthermore, all combinations of at least two of the features disclosed in the description, the drawings and/or the claims fall within the scope of the present invention. The general idea of the present invention is not limited to the precise form or detail of the preferred specific embodiment shown and described below or limited to a subject matter which would be restricted in comparison with the subject matter claimed in the claims. With the stated dimension ranges, values within the specified limits should also be disclosed as limiting values and may be used and claimed as desired. For the sake of simplicity, the same reference numerals are used below for identical or similar parts or parts having identical or similar functions.

Additional advantages, features and details of the present invention are derived from the following description of preferred exemplary embodiments and on the basis of the drawings.

FIGS. 1A, 1B show a schematic view of a measuring device in the form of a handheld device for noncontact distance measurement in a front view (FIG. 1A) and a side view (FIG. 1B);

FIGS. 2A, 2B show two particularly preferred variants of the measuring device from FIG. 1A, 1B with a varied distance measuring unit—having biaxial beam guidance in FIG. 2A and coaxial beam guidance in FIG. 2B;

FIGS. 3A, 3B show an illustrative diagram of the influences of a device rotation (A) onto a distance measurement and the limits thereof for measuring a lateral distance which could so far be determined only indirectly on a surface of the target object;

FIGS. 4A, 4B show two particularly preferred variants of the measuring device of FIG. 1 having a varied relative configuration of the distance measuring unit and the image processing unit—with biaxial beam guidance in FIG. 4A and with coaxial beam guidance in FIG. 4B;

FIG. 5 shows a schematic diagram of the system of a distance measurement in combination with a photoelectric image acquisition unit for determining lateral distances in a surface of a target object using a focal length and a pixel variable as reference measures for at least approximate determination of an image scale to be able to define an image conversion factor;

FIG. 6 shows the design of a control and computation unit having a process sequence for implementation in a distance module of the control and computation unit with allocation of a distance measure to a pixel distance between two pixels of a photoelectric image of the photoelectric image acquisition unit;

FIG. 7 shows the refined modular design of a control and computation unit having the distance module on the basis of the process sequence of FIG. 6;

FIG. 8 shows a first preferred application of the measuring device for ascertaining distinctive distances in an essentially lateral plane of a target object, in the form of a building wall in the present case, where the lateral plane is essentially parallel to the plane of the image of the photoelectric image of the camera lens;

FIG. 9 shows an effect of an affinity transformation, which is shown as an example and may be implemented using a transformation module of FIG. 7 in the control and computation unit;

FIG. 10 shows a first preferred representation possibility of the photoelectric image on an electronic display unit with additional specification of distance measures of distinctive lengths which are directly visible to the user together with an advantageous touchscreen operator option for display of a surface measure;

FIG. 11 shows a second preferred representation possibility of a photoelectric image together with a distance measure on a photoelectric display unit.

### DETAILED DESCRIPTION

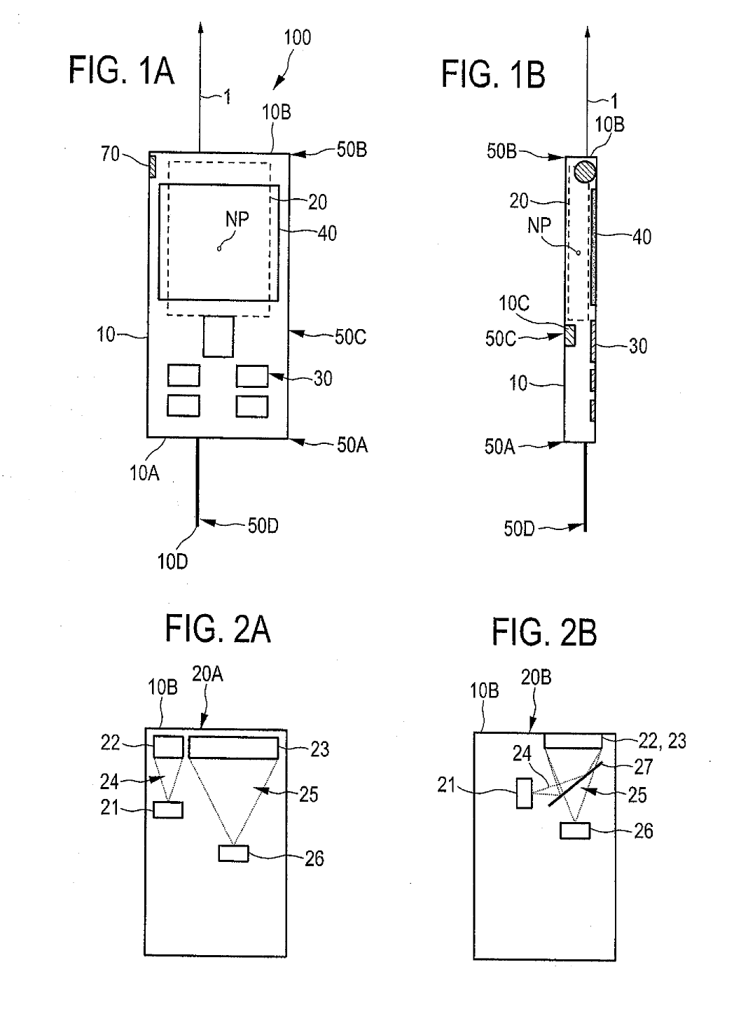

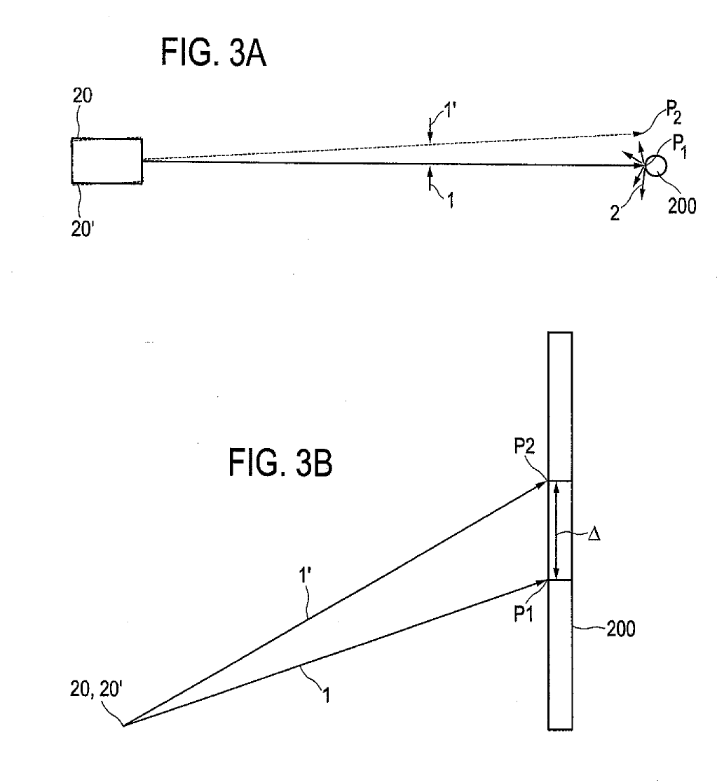

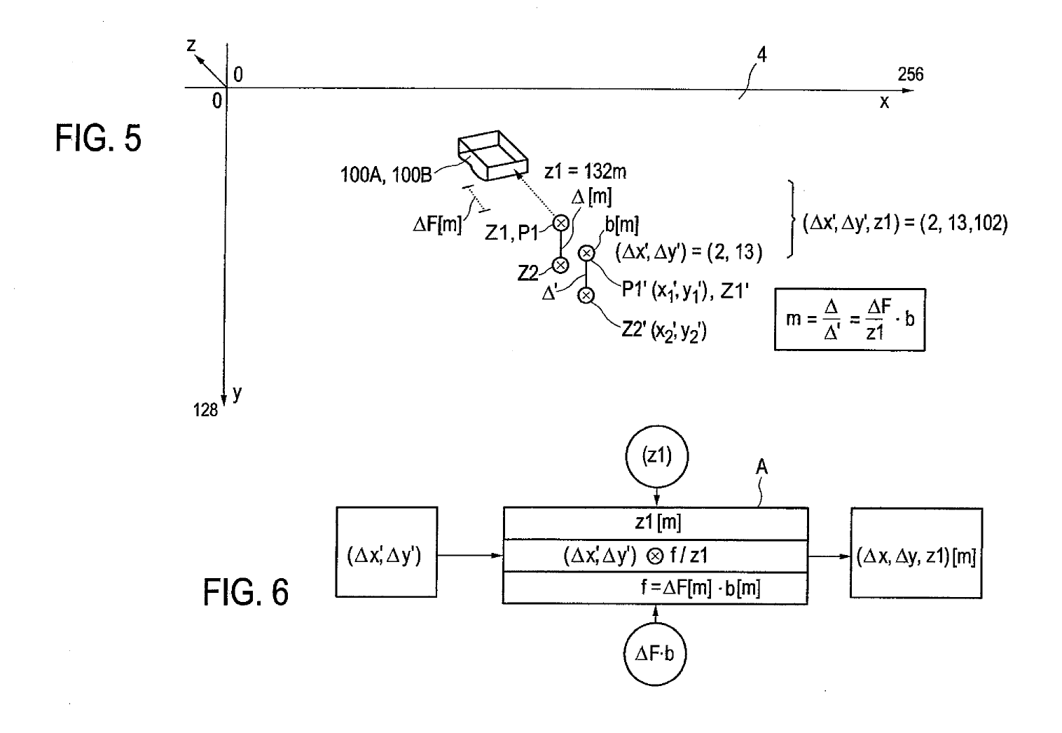

FIGS. 1A and 1B show a measuring device 100 in the form of a handheld device for a noncontact measurement of a distance z, which is defined more precisely in FIG. 5, to a target object 200 shown as an example in FIGS. 3A and 3B. Measuring device 100 is shown in a top view of an operator side of housing 10 in FIG. 1A and in a side view of housing 10 in FIG. 1B—the components of measuring device 100 are represented schematically.

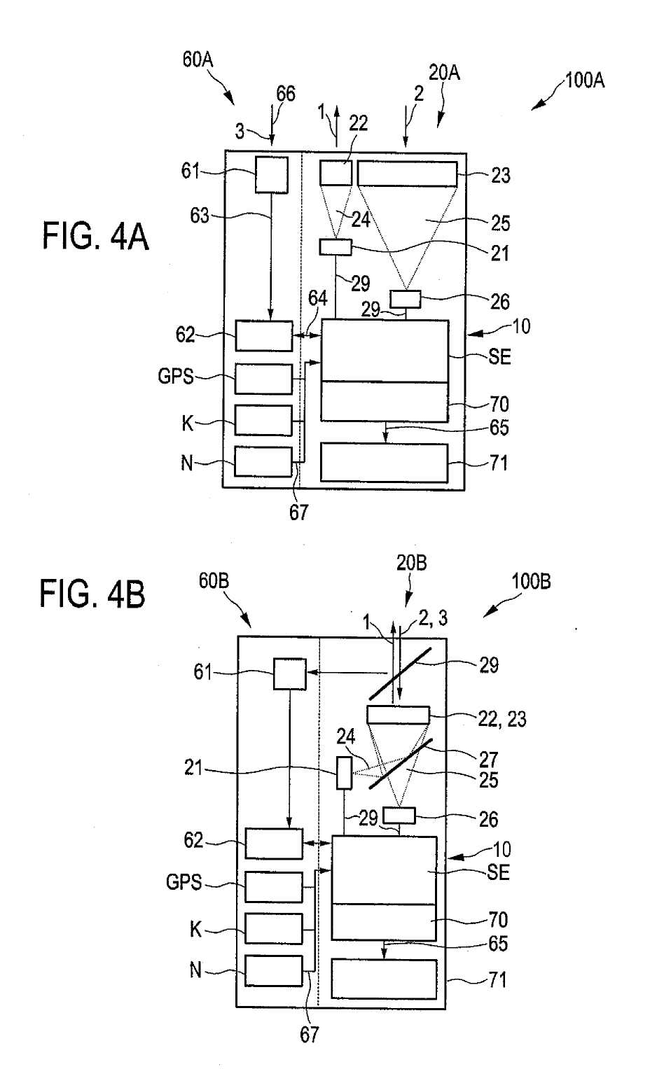

Housing 10 of measuring device 100 which is designed in the form of a laser distance measuring device for example, is designed for manual use—so in the present case, it is not insignificantly larger than the area of a hand with corresponding haptics, possibly also ergonomics. Likewise, housing 10 is shown as a rectangle for the sake of simplicity. Housing 10 accommodates distance measuring unit 20 in the form of a laser distance measuring unit utilizing optical measuring beam 1. Possible variants of distance measuring unit 20 are shown in FIGS. 2A and 2B which are refined as preferred specific embodiments according to FIGS. 4A and 4B. Different handling situations for noncontact measurement of a distance z to a target object are shown in greater detail in FIGS. 3A and 3B.

Measuring device 100 has an operating and input configuration 30, which is situated on housing 10 and is formed in the present case as a keypad embedded in the operating side of housing 10. A visual display 40 is embedded on the operating side of housing 10, so that in the present case both measured distance z between distance measuring device 100 and a target object 200 and the operating state of distance measuring device 100 may be displayed there. Distance measuring unit 20 is operable via the operating and input configuration 30. One of the reference stops 50A, 50B, 50C or 50D of housing 10, which is explained below, may be selected, for example. Whereas the measurement via optical measuring beam 1 (a laser beam here, for example) is based on a reference point NP within the housing, a user will usually want to measure the distance to target object 200 with respect to one of reference stops 50A, 50B, 50C or 50D. When the reference stop is selected by a user, for example, via operating and input configuration 30, distance z may be based on various reference stops using fixed addition constants. The most important reference stop 50A is mounted on the rear side 10A of the instrument. Furthermore, there are other reference stops 50B, 50C, 50D, for example, on the front side 10B of the instrument or on a tip 10D of a measurement extension or on a fastening 10C for a stand thread whose midpoint may also function as reference stop 50C.

For the sake of simplicity the same reference numerals are used below for identical or similar parts or parts having an identical or similar function. FIGS. 4A and 4B show refined specific embodiments according to a first and second variant of a distance measuring unit 20A and 20B which may be used in a measuring device 100 as distance measuring unit 20 according to the concept of the present invention. Reference is made first here to FIG. 2A and FIG. 2B.

To determine a distance between a target object 200 (See FIG. 3A, e.g.) and reference point NP of measuring device 100, the methods described in the introduction may be used. In the present case, distance measuring device 100 has a distance measuring unit 20 which uses an optical measuring beam 1 based on a travel time measurement. Two variants of distance measuring unit 20A, 20B, such as those which may be used for a distance measuring unit 20 as the distance measuring unit are shown as examples in FIGS. 2A and 2B. Both distance measuring units 20A, 20B have a laser unit 21, for example, a laser diode and transmission optics 22 and reception optics 23. Distance measuring unit 20A, 20B also has an optical transmission path 24 having an optical axis for emitting measuring beam 1, which is a laser beam here, to target object 200. Furthermore, distance measuring unit 20A, 20B has an optical reception path 25 having an optical axis for receiving measuring beam 2 reflected or backscattered by target object 200. A detector 26, e.g., a photodiode for detecting the reflected and/or backscattered measuring beam 2, is situated in reception path 25. Reception optics 23 is used for focusing reflected and/or backscattered measuring beam 2 on detector 26 in both cases of distance measuring unit 20A, 20B. Distance measuring unit 20A is provided with separate transmission optics 22 and reception optics 23, so that transmission path 24 and reception path 25 do not overlap. This arrangement of the paths in distance measuring unit 20A is also referred to as biaxial. In contrast with that, distance measuring unit 20B is provided with a coaxial arrangement of the paths, transmission path 24 and reception path 25 being brought together via a beam splitter 27 and overlap in the two shared transmission and reception optics 22, 23. Transmission path 24 and reception path 25 are each guided separately in the area between laser unit 21 and beam splitter 27 and between detector 26 and beam splitter 27.

In concrete terms—as is also apparent from FIG. 3A—measuring beam 1 of a laser unit 21 in the form of a laser diode is bundled using an optical lens of transmission optics 22 in such a distance measuring unit 20 designed as a laser distance measuring unit or the like. Bundled measuring beam 1 is directed from the front side of housing 10B at target object 200—for example, a measuring point P1 there—and forms a light spot on measuring point P1. Using an optical lens of reception optics 23, measuring beam 2 of this light spot, which is reflected or backscattered and is referred to as scattered light, is imaged on the active surface of a photodiode of detector 26 in the manner explained. Distance measuring unit 20 may be designed to be biaxial or coaxial. To determine the distance from target object 200 to reference point NP of measuring device 100—corresponding to the path back and forth—the laser light of the laser beam is modulated as measuring beam 1. A modulation may be pulsed or sinusoidal. Other forms of modulation are also possible. The modulation takes place in such a way that the time difference between an emitted measuring beam modulation and a received measuring beam modulation is measurable. A simple distance between reference zero point NP of measuring device 100 and target object 200 may thus be inferred based on the factor of the speed of light. This may be calculated in a control unit, for example.

FIG. 3B shows a problematical situation with conventional distance measurements. A distance to measuring point P1 of target object 200 may be determined with the aid of a measuring beam 1, similar to the alignment of distance measuring unit 20 shown in FIG. 3A, and a distance may also be determined via measuring beam 1′ to a target point P2 of target object 200. However, distance A between measuring point P1 and measuring point P2 may be determined only indirectly by calculation, using the two measuring distances obtained with measuring beam 1 and measuring beam 1′ in combination with the angle between the two measuring distances. In other words, distance A in the lateral plane on the surface of target object 200 usually can normally not be determined directly by simple rotation of distance measuring unit 20. Furthermore, even for an indirect determination of distance A, it is necessary to perform at least two separate measurements, namely, on the one hand, the measurement using measuring beam 1 to measuring point P1, and, on the other hand, the measurement using measuring beam 1′ to measuring point P2. This situation occurs frequently in everyday use of a distance measuring unit 20. This pertains in particular to measurement of a lateral surface of a target object 200 with lengths and surfaces therein. For example, this pertains to distinctive lengths and areas, which are predetermined by distinctive target points, for example, at window openings, door openings or the like on building façades. Such indirect dimensions may presently be measured only using very complex photogravimetry apparatuses, as explained in the introduction, or using a combined measurement of two distances and one angle or a combined measurement of two distances and the distance of a horizontal segment in combination with the Pythagorean theorem.

FIGS. 4A and 4B show specific embodiments of a first variant of a distance measuring unit 20A and a second variant of a distance measuring unit 20B, which have been refined according to the concept of the present invention. In both cases, a photoelectric image acquisition unit 60A, 60B, which is likewise situated in housing 10 of measuring device 100, is provided in addition to the distance measuring units described in FIGS. 2A and 2B. Each of photoelectric image acquisition units 60A, 60B has a viewfinder and camera lens 61 as well as an image path 66, which connects them but is not explained further here, for detecting target points on a target object 200. A target point may be defined, for example, by the aforementioned measuring point or, as is regularly the case, the aforementioned distinctive points of a building façade. A target point is designated below as Z1, Z2 in contrast with a measuring point P1, P2. These may be identical but in most cases they will not be. The camera lens is designed, for example, in the form of a CCD array or the like, a camera sensor, e.g., a CMOS sensor to which a suitable optical configuration is attached as the viewfinder lens. Image processing unit 62 may be designed in the form of a suitable image processor, with which a photoelectric image 4 of target object 200 (which is explained in greater detail in conjunction with FIG. 5, for example) may be created by processing the image data supplied by the camera sensor.

Measuring devices 100A, 100B differ in the area of the paths and the output optics, which may be implemented as needed, with advantages that tend to be different. Photoelectric image acquisition units 60A and 60B are situated differently in relation to distance measuring units 20A and 20B. In measuring device 100A of FIG. 4A, photoelectric image acquisition unit 60A and image path 66 are formed using separate viewfinder and camera lens 61. In particular, image path 66 is designed to be biaxial to transmission path 24 and biaxial to reception path 25. All paths 66, 24, 25 are biaxial and are situated with separate optics 61, 22, 23 in housing 10 of measuring device 100A.

In measuring device 100B of FIG. 4B, image path 66, transmission path 24 and reception path 25 are combined via a beam splitter 29, which is used jointly by the measuring beam and also the photo light. Both photo light 3 and measuring beam 1 as well as reflected and backscattered measuring beam 2 are guided via a shared output element in the form of additional beam splitter 29 and, if necessary, via additional output optics, such as an output window, output lens or the like. This coaxial arrangement of all paths 66, 24, 25 advantageously prevents parallax errors between the photo light for recording photoelectric image 4 and measuring beam 1, 2 for measuring the distance, so it improves measuring accuracy and reduces the number of output elements or other optical elements required.

For further processing of photoelectric image 4, camera lens 61 is connected to image processing unit 62 via a suitable image data line 63. Image processing unit 62 is connected to control and computation unit SE via another image data line 64. Control and computation unit SE thus has access to information about photoelectric image 4 of photoelectric image acquisition units 60A, 60B. Likewise, control and computation unit SE also has access over a detector signal line 29 to detector signals, which supply a calculated value for distance z1 of measuring point P1 at target object 200 in control and computation unit SE. Information about a photoelectric image 4 processed with the aid of the image processing unit as well as a distance measure of a distance z1 between measuring point P1 and reference point NP may thus be made available with the aid of control and computation unit SE for further processing and/or for the user.

As shown symbolically in FIG. 5, an image of measuring point P1, namely measuring point image P1′ of objective measuring point P1, is part of photoelectric image 4. In the present case, exactly one single photoelectric image 4 from a single recording of target object 200 is provided and exactly one single measuring point P1 is allocated to this single photoelectric image 4. In the present case, as is usually the case, measuring point P1 is covered by the scope of the image and is visible in FIG. 4 as measuring point image P P. Measuring point P1 in the present case also functions as target point Z1 for the sake of simplicity—visible as measuring point image P1′—so that target point image Z1′ in FIG. 5 is labeled with pixel coordinates x1′, y1′. In other words, the image of the locus of measuring point P1 is part of photoelectric image 4 and in the present case is also the target point, for example, a distinctive position such as a window corner or the like on a building façade or the like.

In a situation which is not depicted here, however, measuring point P1 need not necessarily be part of the scope of the image. It is adequate if a plane is definable as the reference plane with the aid of measuring point P1 and distance z1 of measuring point P1 from reference point NP. At any rate, target points Z1, Z2 may be allocated approximately to the reference plane and target points Z1, Z2 are advantageously situated in the reference plane. In particular measuring point P1 does not usually form a target point Z1, i.e., it does not form an end point of a lateral distance A which is to be measured. A measuring point P1 is usually in particular not a distinctive position because the user will, if necessary, define the measuring point by aligning the measuring device with any free point on a surface, for example, a building façade. For example, if one wants to measure a window width, then measuring point P1 is situated somewhere on a wall as a reference plane, for example. Measuring point P1 is relevant for the measurement of distance z1 from device 100A, 100B to the wall as the reference plane. However, in contrast with FIG. 5, it does not usually belong to the number of target points Z1, Z2, which are defined by corner points, for example. To allow the most accurate possible lateral measurement, the measuring laser beam should be perpendicular to the reference plane and the lateral measuring objects defined by target points Z1, Z2 are advantageously situated in the reference plane.

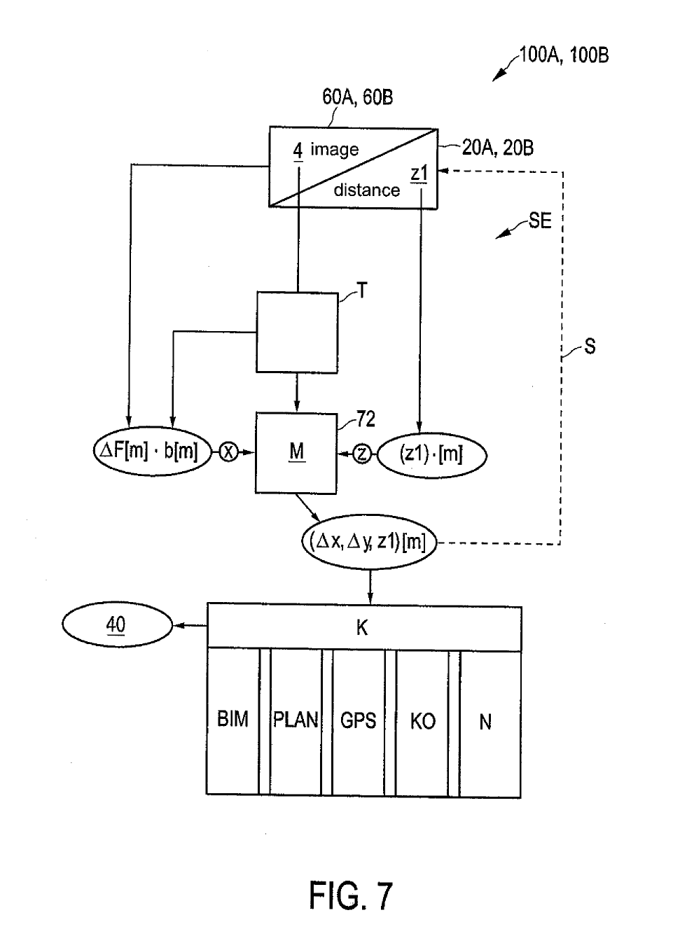

If the latter is not the case, an improvement may be achieved by a perspective rectification. For this purpose a transformation module may be used which is shown in FIG. 7 and may be formed in control and computation unit SE and/or in image processing unit 62.

A recording of target object 200 in the area of measuring point P1 is possible using a single viewfinder and camera lens 61 having a comparatively simple design, as shown in FIGS. 4A and 4B. The comparatively simple design is sufficient for implementing the concept according to the present invention. The viewfinder or camera lens need not be pivotable nor need there be multiple units. In summary, measuring devices 100A, 100B are advantageously designed as simple devices having a distance measuring unit 20A and 20B and a photoelectric image acquisition unit 60A and 60B, a control and computation unit SE additionally being provided which has access to both as a distance measure of distance z1 between reference point NP and measuring point P1 and a definition of a number of pixels of the photoelectric image.

According to the concept of the present invention, this information is present in a mutually self-referencing form, i.e., a measuring point image P1′ (x1′, y1′) defined according to measuring point P1 is allocated to thusly designated distance z1 in FIG. 5. P1 denotes the objective measuring point and P1′ denotes the displayed measuring point image in photoelectric image 4 of the camera. All the variables shown with a prime below refer to image variables without units and all the variables without a prime refer to object variables, e.g., with the unit of meters [m]. Thus, in the present case, distance z1 of reference point NP to measuring point P1 is allocated to measuring point image P1′. For example, the allocation as triple numbers (x1′, y1′, z1 may be available. In the present case, the triple number includes in the first two places the pixel coordinates (x1′, y 1′) defining measuring point P1′ as a pixel in the photoelectric image and in the additional third place distance z1 of measuring point P1 as a distance measure. Such a triple number (x1′, y1′, z1) may be stored in memory 70, for example, by control and computation unit SE and may if necessary be supplied over another data line 65 to an interface 71. Additional display or analysis devices, for example, may be connected to measuring device 100A, 100B via interface 71.

FIG. 5 illustrates in detail the principle according to which control and computation unit SE allocates a defined pixel P1′ corresponding to measuring point P1 and having distance z1 of reference point NP to measuring point P1 according to the principle defined above with the aid of a distance module implemented as software or hardware.

Based on this, a distance module A shown in FIG. 6 uses a distance between a first pixel and a second pixel as a pixel distance and allocates a distance measure (in [m] here) to this using a reference measure f.

Specifically, FIG. 5 shows in this regard the pixel coordinate plane of a photoelectric image 4 as made available by the image processing unit of control and computation unit SE. The pixel coordinate plane predefines in this regard the reference plane, which is formed by distance z1 of the measuring point from reference point NP and the direction of view of the image acquisition unit or the direction of the measuring laser beam, for example, in allocation to a building wall or the like. The pixels in x′ direction are numbered up to 256, and the pixels in y′ direction are numbered up to 128, for example, in the pixel coordinate plane with x′ and y′ directions, but in an actual application the pixel count will be much higher. Exactly one photoelectric image 4, which results from a single recording of target object 200 by measuring device 100A, 100B, is defined in the pixel plane. The target object has measuring point P1 and laterally at a distance A [m] to that in the allocated reference plane, it has target point Z2. Lateral distance A [m] is to be determined. Measuring point P1 in the present case functions as target point Z1, as is explained above for the sake of simplicity.

Measuring point P1 (as first target point Z1 here, for example), which is visible in a lateral surface of target object 200—the reference plane—is also imaged in photoelectric image 4. Measuring point P1 has pixel coordinates x1′, y1′ as measuring point image P1′ (x1′, y1′). Photoelectric image 4 is the result of a single recording by photoelectric image acquisition unit 60A, 60B. To determine a distance measure of distance A [m] between measuring point P1/first target point Z1 and a second target point Z2, the latter is imaged with pixel coordinates x2′, y2′ as second target point image Z2′ (x2′, y2′) in photoelectric image 4. Within the scope of the present specific embodiment, no additional recording of a photoelectric image is initially necessary. Instead, image processing unit 62 is designed to define at least measuring point image P1′ and target point image Z2′ in photoelectric image 4 via pixel coordinates x1′, y1′ and x2′and to define a distance between these pixels, namely between measuring point image P1′ (x1′, y1′) and target point image Z2′ (x2′, y2′), as pixel distance Δ′. This is done, for example, via pixel coordinate differences Δx′=x2′−x1′, Δy′=y2′−y1′. In the present case, pixel distance Δ′ may be selected at will, for example, with pixel coordinate differences (Δx′, Δy′)=(2, 13). A distance measure Δ may be allocated to such a pixel distance Δ′ by distance module A shown in FIG. 6 of control and computation unit SE. The distance in the present case may be given at will using a value 132 in meters [m].

In the present case (a corresponding design of the distance module is shown in FIG. 6), a focal length ΔF, distance z1 of the lateral reference plane and pixel variables bx and by in x and y directions in units of meters [m] are used to ascertain distance A of target points Z1 (measuring point P1 here) and Z2 in units of [m] from pixel coordinate differences Δx′ and Δy′. For example, a comparatively simple computation procedure based on the geometric optics is used in the present case. Accordingly, it follows for distances z1, which are much larger than focal length ΔF:

$$\frac{Δ F}{{z}_{1}} \approx \frac{Δ}{\sqrt{{( {b}_{x} \cdot Δ {x}^{′} )}^{2} + {( {b}_{y} \cdot Δ {y}^{′} )}^{2}}} .$$

It follows from this for distance Δ of target points Z1 (here measuring point P1) and Z2 approximately:

$$Δ = \sqrt{{( Δ x )}^{2} + {( Δ y )}^{2}} \approx \frac{Δ F}{{z}_{1}} \cdot \sqrt{{( {b}_{x} \cdot Δ {x}^{′} )}^{2} + {( {b}_{y} \cdot Δ {y}^{′} )}^{2}}$$

For the same pixel variables bx=by=b, distance Δ of the target points is simplified to

$$Δ = \sqrt{{( Δ x )}^{2} + {( Δ y )}^{2}} \approx \frac{Δ F \cdot b}{{z}_{1}} \sqrt{{( Δ {x}^{′} )}^{2} + {( Δ {y}^{′} )}^{2}} = \frac{Δ F \cdot b}{{z}_{1}} {Δ}^{′} .$$

In abbreviated form, this procedure is illustrated in FIG. 5. As a result, all places of the triple number (Δx, Δy, z1) are given completely in units of meters [m] via distance module A of FIG. 6, and these values are available in memory 70 and/or interface 71 of measuring device 100A, 100B. To this end, distance module A has an input for a reference measure f, which in the present case is formed as the product of focal length ΔF and isotropic pixel variable bx=by=b. Distance module A also has an input for distance z1. An image scale M as the ratio of a focal length (ΔF [m]) and a distance (z [m]) is then multiplied by a pixel variable (b [m]). Image scale M is multiplied by pixel distance Δ′ and thus yields lateral distance Δ.

Due to this clear allocation of measuring point P1 in the lateral plane of target object 200 to a measuring point image P1′ (x1′, y1′) in photoelectric image 4, measured distance z1 to measuring point P1, in particular together with the focal length ΔF of the viewfinder and camera lens 61, may be utilized to ascertain at least approximately an image conversion factor as image scale M=Δ/Δ′=(ΔF/z1·b) for photoelectric image 4. Photoelectric image 4 may thus be quantitatively related to the actual lateral plane of target object 200. Objects such as an edge defined by the pixel coordinate difference (Δx′, Δy′) between P1′ (x1′, y1′) and Z2′ (x2′, y2′) may thus be measured at least approximately.

In such a measurement, a measurement error is the least when the objects are in a plane, in which measuring point P1 is also located, which is preferably aligned perpendicularly to the direction of view of the photoelectric image acquisition unit (reference normal). To this extent, a measurement error is minor in particular when the aforementioned lateral plane stands at least approximately perpendicular to measuring beam 1 on the lateral surface of target object 200. In a subsequent method step, for example, by repeating the procedure depicted in FIGS. 5 and 6, one or more photoelectric images of the same target object 200 or other views of target object 200 associated or overlapping with image 4 may fundamentally be recorded. For example, a panoramic image of multiple photoelectric images may be assembled by computer. For this case, a panoramic image includes multiple photoelectric images or parts thereof, each being allocated to a different measuring point P1, P2, . . . , P_{N} because these are each obtained from the individual measurements and individual recordings. This may be advantageous because the lateral measurement is more accurate and more reliable. Large target objects, which are not detectable with a single recording, may thus be measured in this way.

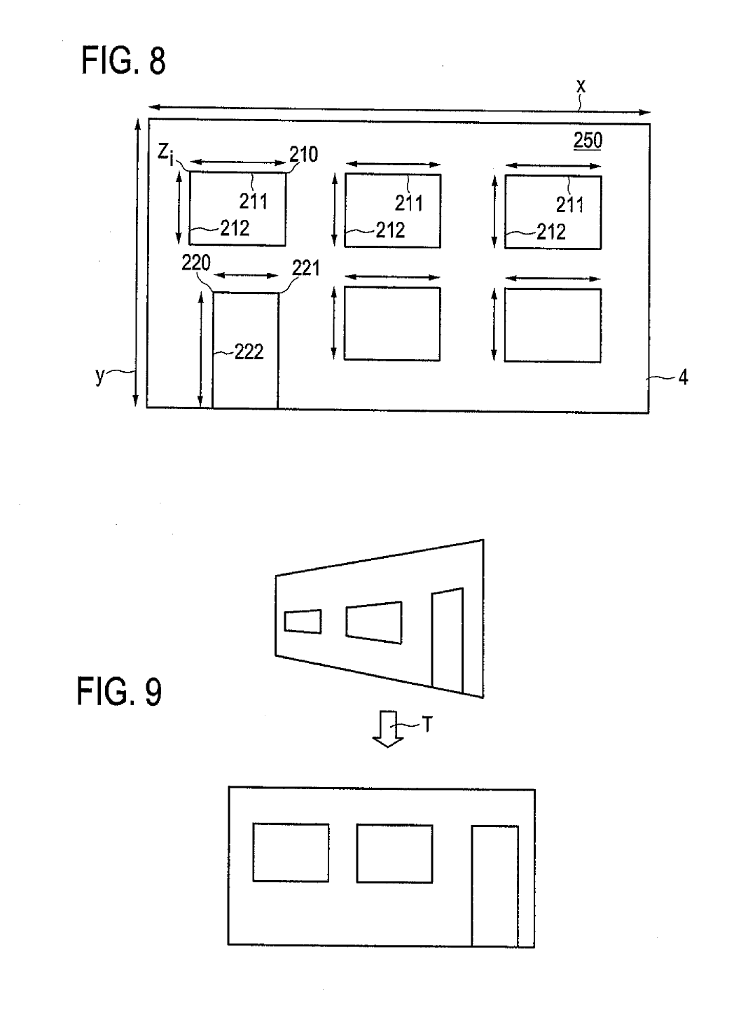

Such a situation is illustrated in FIG. 8 as an example. Photoelectric image 4 of FIG. 8 shows an image of a building façade in a pixel plane, whose coordinates are in turn labeled as x′, y′. Five windows 210 and one door 220 are discernible. In the present case, image processing unit 62 is designed to automatically detect distinctive edges 221, 222 of door 220 and distinctive edges 211, 212 of window 210 via a simple, e.g., contrast-based, image filter function. To do so, a number of distinctive target points Zᵢ may be recorded, each being determined in a particularly high-contrast manner as biaxial points of intersection of window edges 211, 212 or door edges 221, 222. Each edge 211, 212, 221, 222 may in principle be treated like a pixel distance (Δx′, Δy′) of FIG. 5, i.e., a distance measure in units of meters [m], for example, may be allocated to it based on focal length ΔF, distance z1 and pixel variable b. The distance measures are represented as double arrows in FIG. 8 as an example and merely symbolically.

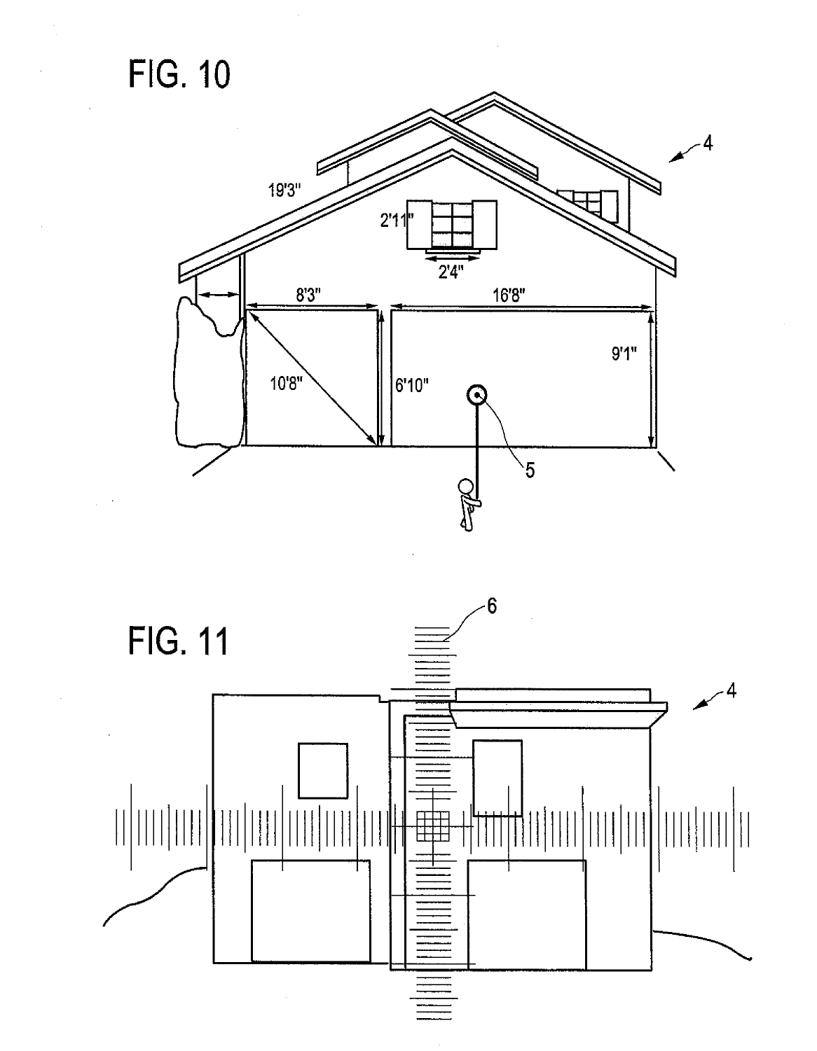

Photoelectric image 4 may be displayed in the form shown in FIG. 8 on an electronic display unit, i.e., with the number of target points Zᵢ, edges 211, 212, 221, 222 and the distance measures which are represented symbolically as double arrows. Thus, together with photoelectric image 4, the user also obtains the at least approximate dimensions of the distinctive parts thereof. A user may also retrieve a surface measure for a window 210 or for a door 220 by selecting, for example, a window 210 via a touchscreen function or operating and input configuration 30 on measuring device 100A, 100B by selecting desired window 210 or desired door 220. In particular, a user may also select façade 230 of photoelectric image 4 to be able to display a surface measure thereof. An exemplary photographic representation of such a result is shown in FIG. 10. Selection symbol 5 in photoelectric image 4 may display to the user that it is possible to retrieve a surface measure—for the garage door in FIG. 10, for example.

The additional display of edge dimensions or other distance dimensions described with reference to FIG. 8 and FIG. 10 together with the photoelectric image may be implemented comparatively easily in an application implemented in the distance module. For this purpose, a suitable algorithm of image processing unit 62 may be designed to recognize object edges, for example, and to automatically dimension them by using the image conversion factor obtained from distance z according to the concept described above. In another application, as illustrated in FIG. 11, a cross-line graticule may be faded in into the image by an image conversion factor, for example, so that real object sizes may be approximately discernible in the image.

With reference to FIG. 7, each measuring device 100A, 100B in the present case has a number of coupling modules K, which are connected to control and computation unit SE. Coupling modules K in the present case are connected to control and computation unit SE via multiple additional data lines 67 designed as a gallery. A first coupling module is designed in the form of a GPS module and identified as such. A second coupling module is designed in the form of a compass KO. A third coupling module is designed in the form of an inclination sensor N. For example, additional information such as GPS data, compass data and inclination data may be ascertained using measuring device 100A, 100B and made available therein for a control and computation unit SE. In addition to recording images 4 via a photoelectric image acquisition unit in the form of the camera and distance values z and distance measured values Δ, simultaneous and real-time recording of additional measured values, for example, the measured data of a GPS unit or a digital compass or measured data of inclination sensors is advantageous. These measured data provide additional information about the location and the measuring direction to a measuring point P1 and are suitable, for example, for compensating the measured values using a plan (PLAN). Thus, the position in a room as well as the observation direction and measuring direction may be ascertained at least approximately by sensor data fusion. Furthermore, a model of the room may be derived or the position of the measuring device in the building may be determined based on plans, CAD data or BIM (building information modeling). Virtual objects may be faded in into camera images (augmented reality), for example, via BIM and the known position and observation direction. This may be, for example, invisible objects embedded into walls or pipes, fastening elements, cable ducts, electrical outlets, etc., which are not yet present.

Another advantageous application of coupling module K is facial recognition using the camera. For example, a laser of distance measuring device 20A, 20B could be deactivated when a person is in the beam path of measuring beam 1.

Data required by other devices for special applications may, if necessary, be read in or input via interface 71 or operating and input configuration 30 and made available for a control and computation unit SE. These may be, for example, data for construction materials such as thermal conductivity values, cost units or the like and may be made available to the control and computation unit. Control and computation unit SE may also be equipped in such a way that distance measures on a lateral surface of a target object 200 (i.e., the reference surface)—for example, those shown in FIG. 10—may be utilized to make available an at least approximate cost analysis or heat loss information. In other words, a measuring device 100A, 100B may already be equipped for making available distance measures together with additional information. Thus a user at a construction site may already make important estimates of costs and required measures as well as the extent thereof on site. This may pertain to the renovation of a façade or a thermal insulation thereof or also the renovation of an interior or the like, for example.

Such data as well as other additional data may be supplied to measuring device 100A, 100B, advantageously to achieve a better attribution of the distance measurements described above. The additional information which is available or may be input via coupling modules K, interface 71 or operating and input configuration 30—optionally including handwritten diagrams, comments or the like—may be placed in photoelectric image 4, for example.

Symbol 5 shown in FIG. 10 may be used as part of an additional advantageous application, for example, as a rapid measurement of a cohesive area on the basis of the camera image and at least one measuring distance. For this purpose, the point in symbol 5 on the garage door in FIG. 10 may be selected, for example, and then the surface area of same may be ascertained. By selecting a window, the total area of glass needed for the façade may be determined and by selecting the house wall its surface area not including windows and doors may be determined. These functions as well as others are extremely useful and advantageous in preparing bids for supply service providers such as painters, plasterers, tilers or glaziers, and available directly at a construction site based on the application.

With additional input of the construction material used, the price may be ascertained automatically on site. Additional information such as GPS data, compass data and input of thermal conductivity values (K value) permits an on-site calculation of heat loss and the corresponding costs.

FIG. 7 shows the whole system of a control and computation unit SE and its peripherals as part of distance measuring device 20A, 20B and image acquisition unit 60A, 60B. While distance measuring device 20A, 20B supplies a distance z1 and a distance measure in meters [m], a focal length ΔF for determining a reference measure fin the photoelectric image may initially be supplied via photoelectric image acquisition unit 60A, 60B. Finally, a scale M is formed from these measuring data in a multiplication unit of distance module 72 of control and computation unit SE. The corresponding triple number of distance z1 and of lateral distance Δ and coordinate distances Δx, Δy for which two pixels Z1′, Z2′—or measuring point P1′ here—are each obtained in meters in a manner described above as an example. As explained, this triple number may be combined with additional applications within the context of BIM or GPS or plan recognition via a coupling module K. The results of a measured data allocation and collection combined in this way may be grouped simultaneously or individually or as needed by the user and displayed in a visual display 40 of measuring device 100A, 100B.

FIG. 7 also shows one advantageous refinement of control and computation unit SE and/or image processing unit 62 with the aid of a transformation module T. As is discernible in the upper part of FIG. 9, measuring objects of a target object 200 in other lateral surfaces of target object 200 which are not parallel may undergo a perspective distortion—for example, to a vanishing point as shown here. Since parallel lines here converge at a vanishing point, a perspective rectification, the result of which is shown in the lower portion of FIG. 9, may be performed here using a suitable algorithm, in particular by image processing unit 62. The corresponding transformation may be performed by transformation module T as part of an affinity transformation of photoelectric image 4. Objects not situated in lateral reference plane 4, in which measuring point P1 is located, are then seemingly smaller or larger in the photoelectric image—in comparison with a farther or closer arrangement of same in relation to the measured distance from measuring point P1. Here again, a correction may be performed using the vanishing point analysis. Furthermore, multiple distance measurements may be recorded with the corresponding photoelectric images. According to the concept of the present invention, exactly one measuring point P1 is allocated to each individual photoelectric image 4 of this series because it is recorded with the photoelectric image. The sequence of pairs of photoelectric image 4 and measuring point Pj may be perspectively corrected—within the context of an application in an implemented imaging process algorithm, if needed—and then combined to form a single image having multiple imaged measuring points P1′, P2′, . . . . This application may be utilized by the user as a very efficient approach to building information modeling. Thus even very large measuring objects which cannot be detected with a single image may be recorded, pieced together and then measured according to the concept of the present invention with the aid of a focal length ΔF as the reference measure.

Various distance measurements, each belonging to one photoelectric image, may be provided, for example, for one measuring point P1, P2, P3, etc., and also permit a more accurate perspective rectification. This is due to the fact that additional information about the angle of the object planes may be derived from the various measured values and measuring spot positions. In addition, the movement of the measuring device during the recording of the measured data may also be taken into account by using an inertial navigation system (triaxial acceleration sensors, triaxial gyroscope or the like). Such transformations as well as others may be implemented within the scope of transformation module T in order to make available to the user in conclusion a corrected and rectified measuring surface including dimensioning as shown at the bottom of FIG. 9.

Furthermore, the computation and control unit may include an evaluation algorithm module which tests the quality of the measuring points and eliminates invalid measuring points (e.g., measurements through doors or windows or bypassing the house wall) on the one hand or, on the other hand, proposes suitable measuring points in the camera image to the user.

As FIG. 7 also shows, in a subsequent method step—for example, by repeating the procedure illustrated in FIGS. 5 and 6 in a loop S—one or more photoelectric images of the same target object 200 or other views of target object 200 which overlap or which belong together with image 4 may be recorded. Thus a panoramic image of multiple photoelectric images may be compiled by computer. For this case a panoramic image contains multiple photoelectric images or parts thereof, each of which is allocated to another measuring point P1, P2, . . . , P_{N} since they are the result of individual measurements and individual recordings. This may be advantageous because the lateral measurement is more reliable and more accurate.

What is claimed is:

1. A measuring device for a noncontact measurement of distances on a target object, the measuring device comprising:
a housing;
a distance measurer situated in the housing and utilizing an optical measuring beam, with aid of which a distance between a reference point and at least one measuring point on the target object is measurable without contact;
a photoelectric image acquirer situated in the housing, having a viewfinder and camera lens as well as an image path connecting the viewfinder and the camera lens for detecting target points of the target object;
an image processor for creating a photoelectric image of the target object; and
a controller capable of computation, the photoelectric image of the image processor being displayable with the aid of the controller,
the image processor designed to define at least a number of target points as a plurality of pixels in exactly one single image of the photoelectric image,
the controller designed to allocate the distance of the reference point to the measuring point to at least one of the pixels and to make the allocation available for further processing.

2. The measuring device as recited in claim 1 wherein the controller has a distance module designed to define a distance between a first pixel and a second pixel of the plurality of pixels as a pixel distance and to allocate a distance measure of the target points to the pixel distance.

3. The measuring device as recited in claim 2 wherein the distance module has an input for at least one reference measure and is designed to determine from the at least one reference measure at least approximately one image scale with the aid of which the distance measure is to be allocated to the pixel distance.

4. The measuring device as recited in claim 3 wherein the at least one reference measure at least includes: a focal length of the viewfinder lens and camera lens and/or a pixel variable.

5. The measuring device as recited in claim 1 wherein the exactly one single photoelectric image results from a single recording of the target object, and exactly one measuring point is allocated to the photoelectric image.

6. The measuring device as recited in claim 2 wherein the distance module and/or the image processing unit is/are designed to define a plurality of distance measures between a plurality of target points.

7. The measuring device as recited in claim 1 wherein the controller has a joining module designed to combine a plurality of individual photoelectric images, each resulting from a single recording of the target object, each with exactly one corresponding measuring point to assemble them.

8. The measuring device as recited in claim 2 wherein the distance module is designed to allocate a plurality of distance measures between a plurality of target points to the pixel distance of pixels of the photoelectric image.

9. The measuring device as recited in claim 2 wherein the distance module is designed to define a surface measure within a polyhedron defined by a plurality of target points with the corresponding pixels.

10. The measuring device as recited in claim 1 wherein an electronic visual display in the housing is designed to display at least one distance measure and/or surface measure in the image.

11. The measuring device as recited in claim 1 wherein an electronic visual display in the housing is designed to display a distance of the reference point to the measuring point.

12. The measuring device as recited in claim 1 wherein the photoelectric image acquirer has a single viewfinder lens and camera lens.

13. The measuring device as recited in claim 1 wherein an image path of the image acquirer is guided via separate viewfinder lens biaxially to a transmission and/or reception path of the distance measurer, or the image path is guided coaxially to the transmission and/or reception path via a shared output element of transmission and/or reception optics on the one hand and the viewfinder lens on the other hand.

14. The measuring device as recited in claim 1 wherein the controller and/or the image processor has/have a transformation module designed to make available to a distance module a correction measure for a perspective distortion of a target object.

15. The measuring device as recited in claim 1 wherein distinctive target points are selectable automatically with the aid of the image processor or with the aid of an operating and input configuration and/or a visual display to define the plurality of the pixels.

16. The measuring device as recited in claim 1 wherein the controller has a coupling module, an output of a distance module being couplable via the coupling module to an input of a plan memory of a GPS system or distance information carrier.

17. The measuring device as recited in claim 1 wherein the image processor defines the measuring point as one of the plurality of pixels.

18. The measuring device as recited in claim 1 wherein the measuring device is in the form of a handheld device, and the housing is designed for manual use.

19. The measuring device as recited in claim 1 wherein measurement of the distance is made with the aid of a travel time measurement.

20. A method for noncontact measurement of distances on a target object comprising the steps:
measuring in a noncontact fashion a distance between a reference point and at least one measuring point on the target object;
acquiring a photoelectric image of the target object;
displaying the photoelectric image;
defining at least a number of target points as a plurality of pixels in exactly one single photoelectric image; and
allocating the distance of the reference point to the measuring point to at least one of the pixels and making available the allocation for further processing.

21. The method as recited in claim 20 wherein a distance between a first pixel and a second pixel is defined as a pixel distance, and a distance measure is allocated to the pixel distance.

22. The method as recited in claim 22 wherein from at least one reference measure, including a focal length of a viewfinder lens and camera lens and/or a pixel variable, an image scale is determined at least approximately with aid of which the distance measure is to be allocated to the pixel distance.

23. The method as recited in claim 20 wherein an image scale is determined as a ratio of a focal length and a distance multiplied by a pixel variable.

24. The method as recited in claim 20 wherein measurement is made with a measuring device includes a housing; a distance measurer situated in the housing and utilizing an optical measuring beam, with aid of which a distance z between a reference point and at least one measuring point on the target object is measurable without contact; a photoelectric image acquirer situated in the housing, having a viewfinder and camera lens as well as an image path connecting the viewfinder and the camera lens for detecting target points of the target object; an image processor for creating a photoelectric image of the target object; and a controller capable of computation, the photoelectric image of the image processor being displayable with the aid of the controller, the image processor designed to define at least a number of target points as a plurality of pixels in exactly one single image of the photoelectric image, the controller designed to allocate the distance of the reference point to the measuring point to at least one of the pixels and to make the allocation available for further processing.

25. The method as recited in claim 24 wherein the measuring device is a handheld device.

26. The method as recited in claim 20 wherein the measuring in noncontact fashion is made with the aid of a travel time measurement.
